(19) United States
(12) Patent Application Publication
(10) Pub. No.: US 2008/0232804 A1
(43) Pub. Date: Sep. 25, 2008

(54) PON WITH PROTECTED CROSS-CONNECT FORWARDING

(76) Inventor: Luc ABSILLIS, Raleigh, NC (US)

Correspondence Address: Gardner Groff Greenwald and Villanueva, PC, 2018 Powers Ferry Road, Suite 800, Atlanta, GA, 30339, US

(21) Appl. No.: 11/687,726

(22) Filed: Mar. 19, 2007

(51) Int. Cl. H04J 14/00

(52) U.S. Cl. 398/71

(57) ABSTRACT

Redundancy is provided in a passive optical network (PON) to protect against network malfunctions or provide other benefits. The Optical Line Terminal (OLT) that couples an external network to the PON routes network traffic via one or, alternatively, both of two paths or links between the OLT and a subscriber device. The subscriber device is coupled to two Optical Network Terminators (ONTs), each of which, along with a portion of the fiber network, forms part of one of the links.

### BACKGROUND OF THE INVENTION

1. Field of the Invention

The present invention relates generally to passive optical networks (PONs) and, more specifically, to providing a PON with means for protecting against network malfunctions.

2. Description of the Related Art

The passive optical network (PON) is gaining increasing acceptance as an access network for delivering broadband services such as Internet access, digital television and telephone service, to residential and business subscribers. The essence of a PON is that nothing but optical fiber and passive components are found in the path between the central office and subscribers. A single fiber can run from the central office to a passive splitter located near a group of subscribers, such as a neighborhood or office complex, and individual fibers can run from the splitter to individual subscribers or sub-groups of subscribers. The International Telecommunications Union (ITU) and the Institute of Electrical and Electronics Engineers (IEEE) are two standards-making bodies currently developing PON standards. The ITU has adopted recommendations of the Full Service Access Networks (FSAN) organization, including G983.x, a specification sometimes referred to as “broadband PON” (BPON), and G984.x, a specification sometimes referred to as “gigabit PON” (GPON). The IEEE has also adopted Ethernet-based (i.e., IEEE 802.3-based) PON standards referred to as “Ethernet PON” (EPON) and “gigabit EPON” (GEPON). These standards and recommendations are well known to persons skilled in the art to which the invention relates and are therefore not described in further detail in this patent specification. Although the term GPON may be used herein for convenience with regard to embodiments of the present invention described below, the invention can be applied to any suitable PON technology.

In accordance with these standards, a PON comprises an Optical Line Terminal (OLT) (also known as optical line terminator), which is typically located at the central office, and a number of Optical Network Terminators (ONTs) (also known as optical network terminals and optical network units), each located at the subscriber's premises (e.g., home, office building, etc.), with optical fiber and one or more splitters between the OLT and ONTs. In the downstream direction, i.e., data transmitted from the OLT (e.g., located at the central office) to an ONT (e.g., located at a subscriber's premises), the data units are broadcast from the OLT to all of the ONTs on the PON, and an ONT can select the data to receive by matching the address embedded in the data units to a previously provisioned or learned address. In other words, an ONT only “listens” to data units having a matching address. Thus, the OLT can transmit data “downstream” to a particular or selected ONT by addressing it to that ONT. In the “upstream” direction, i.e., data transmitted from an ONT to the OLT, the data units are time-domain multiplexed. In GPON, the downstream address typically comprises both a conventional Ethernet MAC address as well as a GPON Encapsulation Method (GEM) Port-ID. The GEM Port-ID can be used as a Quality-of-Service (QoS) designator to address a priority queue on a particular user port on a subscriber ONT, such as a queue for high speed internet traffic, a queue for packet telephony, a queue for video traffic etc. Quality of Service (QoS) is, generally speaking, a term that refers to assigning data packets different priorities based upon the type of data they carry. For example, real-time streaming video (i.e., digital television) service is generally assigned a higher priority than Internet Web browsing and e-mail. In this manner, demands placed upon the network by multiple subscribers simultaneously requesting different services are less likely to diminish any subscriber's individual perception of service quality. QoS differentiation is an important aspect of GPON systems, as the QoS designator is generally used to define the virtual paths between the OLT and the ONT subscriber ports.

As illustrated in FIG. 1, in a conventional arrangement for delivering services to subscribers, a PON 10 that serves as the access network for subscribers includes an OLT 12 optically coupled to a number of ONTs 14 by an arrangement of optical fibers 16 that includes one or more optical splitters (not separately shown for purposes of clarity). Each ONT 14 is connected to one or more subscriber gateway devices 18 to which subscribers can connect devices (not shown) such as Ethernet routers, televisions, telephones, etc. Note that OLT 12 potentially communicates with ONTs 14 via a multiplicity of PON virtual paths (or links) defined by the QoS designator (e.g., GEM Port-ID), conceptually indicated in FIG. 1 by the multiplicity of dashed lines at the ends of fibers 16.

The OLT 12 includes what is commonly referred to as a “transparent cross-connect” 20 that maps the above-described PON virtual paths (defined by the GEM Port-ID or other QoS designator) to the service provider's virtual local area network (SVLAN). In some instances, such as for business subscribers rather than residential subscribers, the service provider assigns each subscriber a unique SVLAN to separate the traffic associated with that subscriber from the traffic associated with other subscribers. The term “cross-connect” refers to the one-to-one relationship or correspondence between each ONT user-network interface (UNI) port and one SVLAN. The term “transparent” refers to the tunneling mode, in which OLT 12 encapsulates a packet received from an ONT 14 by inserting an SVLAN-ID in the Ethernet frame before forwarding the packet to the service provider's aggregation network 22. Aggregation network 22 is typically Gigabit Ethernet-based. The above-described SVLANs defined by the SVLAN-ID are conceptually indicated in FIG. 1 by the multiplicity of dashed lines at the ends of an Ethernet cable 24 or similar medium that connects Ethernet aggregation network 22 with PON 10.

It is known to include redundant mechanisms within a conventional Ethernet network such as aggregation network 22 to protect against adverse effects of network malfunctions. For example, the Ethernet routers, switches, etc., that make up network 22 commonly include redundant mechanisms such as multiple parallel termination cards and cables, link aggregation, dual-homing, etc. Link aggregation in the Ethernet context is defined by the IEEE 802.3ad standard and refers to the parallel grouping of two or more data paths or links such that a port treats them as a single link.

Although mechanisms to protect against network malfunctions are commonly employed in conventional Ethernet networks, few such mechanisms have been suggested for PONs. It would be desirable to provide protection mechanisms in a PON. The present invention addresses these problems and deficiencies and others in the manner described below.

### SUMMARY OF THE INVENTION

The present invention relates to providing redundancy in a passive optical network (PON) to protect against network or equipment malfunctions or provide other benefits. In an exemplary embodiment of the invention, the Optical Line Terminal (OLT) that couples an external network to the PON routes network traffic via either or, alternatively, both of two redundant paths (or links) between the OLT and a subscriber device. (In other embodiments the PON can include more than two such redundant links.) A subscriber device, such as a gateway, is coupled to two Optical Network Terminators (ONTs), each of which, along with a portion of the fiber network, forms part of one of the links.

Network traffic can be routed via one or both links in either the upstream (i.e., from the subscriber device to the OLT) or downstream (i.e., from the OLT to the subscriber device) direction in response to any suitable condition or on any suitable basis. For example, in some embodiments of the invention network traffic in both directions can be routed via the first link until a condition, such as a network malfunction, is detected, whereupon traffic is re-routed via the second link. In some embodiments of the invention, only upstream traffic is re-routed, while in other embodiments only downstream traffic is re-routed, while in still other embodiments traffic is re-routed bidirectionally. In another routing example, in some embodiments of the invention traffic is apportioned or divided between the first and second link so as to, for example, balance the load between the links and thereby effectively increase network bandwidth. In some such embodiments of the invention, only upstream data is apportioned, while in other embodiments only downstream data is apportioned, while in still other embodiments data is apportioned bidirectionally. Still other embodiments will occur readily to persons of skill in the art in view of the teachings herein.

### BRIEF DESCRIPTION OF THE DRAWINGS

FIG. 1 is a block diagram of prior art network.

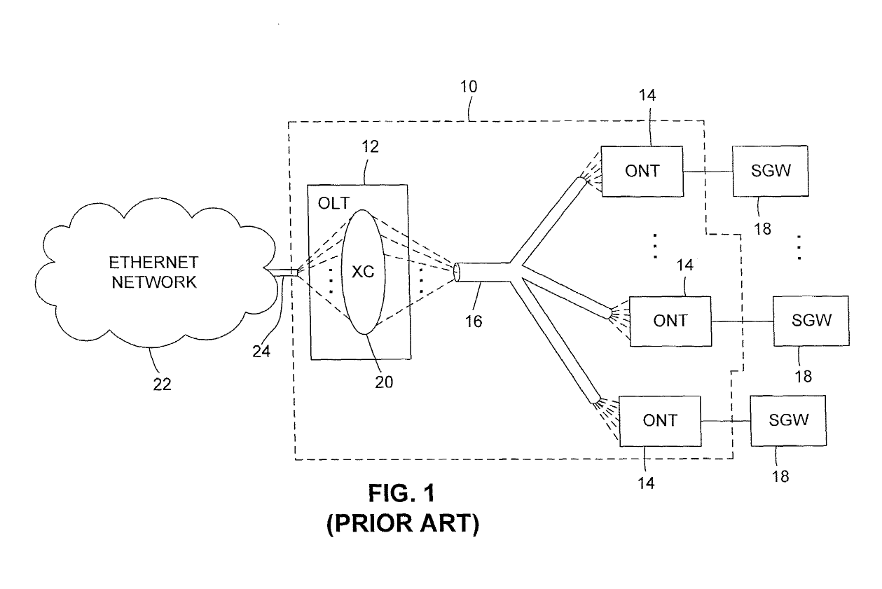

FIG. 2 is a block diagram of a network in accordance with an exemplary embodiment of the present invention.

FIG. 3 is a block diagram of the Optical Line Terminal (OLT) of the network of FIG. 2.

FIG. 4 is a flow diagram, illustrating an exemplary traffic routing method in the network in FIG. 2.

FIG. 5 is a flow diagram, illustrating another exemplary traffic routing method in the network in FIG. 2.

FIG. 6 is a flow diagram, illustrating still another exemplary traffic routing method in the network in FIG. 2.

FIG. 7 is a flow diagram, illustrating yet another exemplary traffic routing method in the network in FIG. 2.

### DETAILED DESCRIPTION

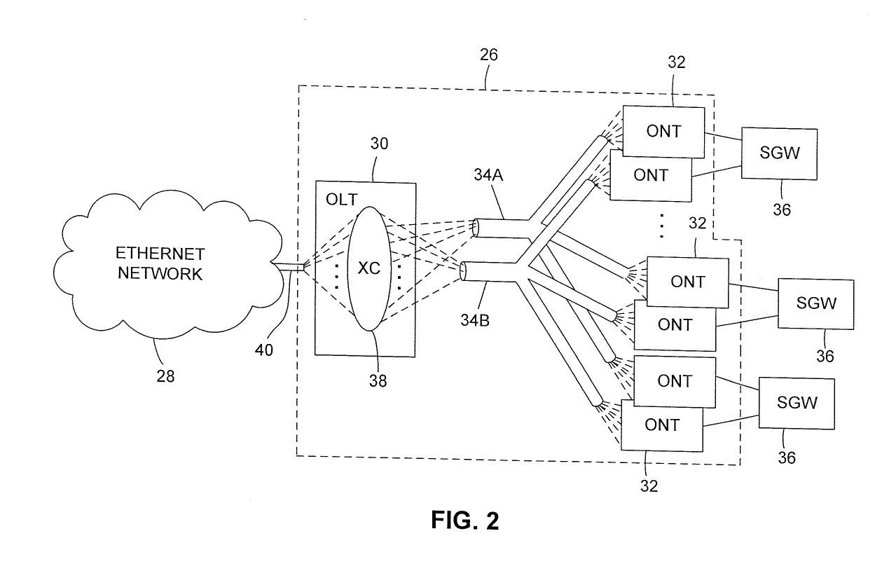

As illustrated in FIG. 2, in an exemplary embodiment of the invention, an extended data network for delivering services such as voice, video and Internet access to subscribers comprises a passive optical network (PON) 26 and an Ethernet-based aggregation network 28. The PON 26 includes an Optical Line Terminal (OLT) 30 and a number of Optical Network Terminators (ONTS) 32. (The ellipsis symbol (“ . . . ”) is intended to indicate that, although only six ONTs 32 are shown for purposes of clarity, PON 26 can include any suitable number of ONTs.) The OLT 30 is optically coupled to each ONT 32 by optical fiber network portions 34A and 34B that include one or more optical splitters (not separately shown for purposes of clarity). The OLT 30 can be located at, for example, an exchange or central office from which the service provider provides services such as Internet access, telephone and television service (so-called “triple-play” service). The ONTs 32 can be located at or near the businesses, residences or other premises occupied by subscribers to such services. Also located at or near such premises are subscriber gateway devices 36, each of which is coupled to two ONTs 32.

Each of subscriber gateway devices 36 can communicate data with OLT 30 via two independent paths (or links), the first one through a first ONT 32 coupled to OLT 30 via optical fiber network portion 34A and the second one through a second ONT 32 coupled to OLT 30 via optical fiber network portion 34B. As conceptually or logically illustrated in FIG. 2, OLT 30 includes cross-connect logic 38 that not only maps the PON virtual paths (defined by the GEM Port-ID's and indicated in FIG. 2 by the dashed lines at the ends of optical fiber network portions 34A and 34B) to the service provider's virtual local area networks (SVLANs, indicated by the dashed lines at the ends of the Ethernet cable or cables 40) but also selects whether the connection between the PON virtual path and the corresponding SVLAN is via the first link or the second link, i.e., via the link that includes optical fiber network portion 34A and a first ONT 32 or via the link that includes optical fiber network portion 34B and a second ONT 32. Exemplary selection methods are described in further detail below.

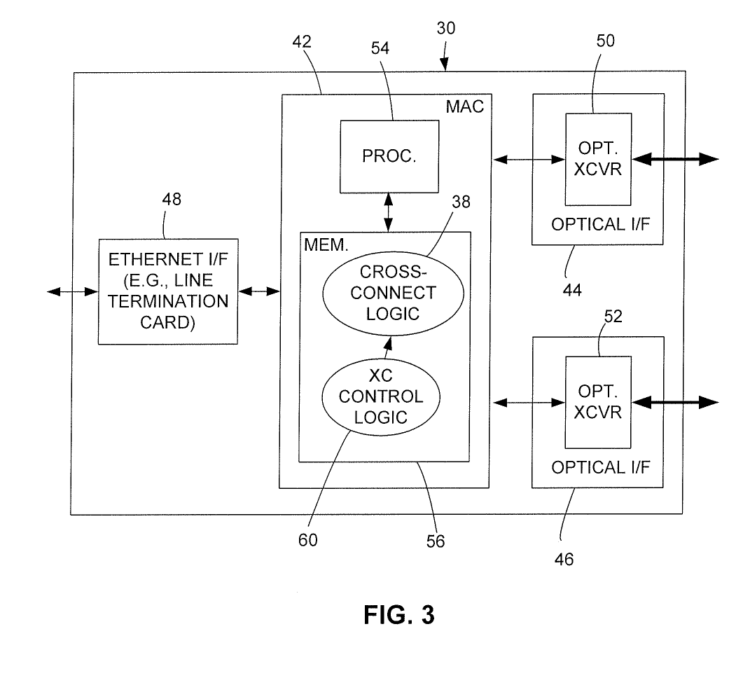

As illustrated in FIG. 3, OLT 30 comprises a media access controller (MAC) 42, a first line terminator card or other optical interface 44, a second line terminator card or other optical interface 46, and an Ethernet terminator card or similar Ethernet interface 48. Ethernet interface 48 is the physical interface between OLT 30 and aggregation network 28 (FIG. 2). Similarly, optical interface 44 is the physical interface between OLT 30 and optical fiber network portion 34A, while optical interface 46 is the physical interface between OLT 30 and optical fiber network portion 34B. Accordingly, optical interfaces 44 and 46 include opto-electronic transceivers 50 and 52, respectively, as well as other elements (not shown for purposes of clarity) of the type generally included in such OLT optical interfaces. As the general manner in which an OLT transmits, receives and otherwise processes GPON packets is well known in the art, it is not described herein. As in the MAC of conventional OLTs, MAC 42 performs the bulk of the processing required to deliver the services requested through ONTs 32. In addition to the novel features and functions described below, MAC 42 can include any features of conventional MACs and can perform any suitable conventional functions.

In the exemplary embodiment of the invention, MAC 42 includes a processor 54 and associated memory 56 that together define a processor system of a type in which processor 54 operates under software control. However, in other embodiments the OLT processor system can include any other suitable elements, such as programmable or hard-wired logic devices, firmware logic, software logic, application-specific integrated circuit logic, etc., in addition to or in place of the illustrated elements, that allow the processor system to be programmed or otherwise configured to perform the functions described below as well as functions performed by a conventional OLT MAC. In the illustrated embodiment, cross-connect (“XC”) logic 38 and cross-connect control logic 60 are shown for purposes of illustration as conceptually stored in or residing in memory 56, with the processor system operating under control of such software elements and thus performing or causing to be performed the functions described in further detail below. However, as persons skilled in the art to which the invention relates can appreciate, such software elements may not actually reside in memory 56 simultaneously or in their entireties; rather, portions thereof may be retrieved to memory 56 and executed on an as-needed basis in the conventional manner. Other software elements of the types under which a conventional MAC is controlled are not shown for purposes of clarity.

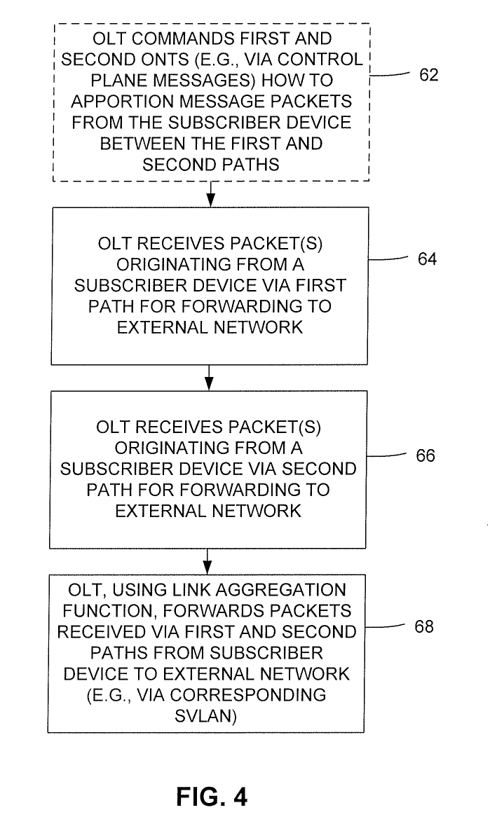

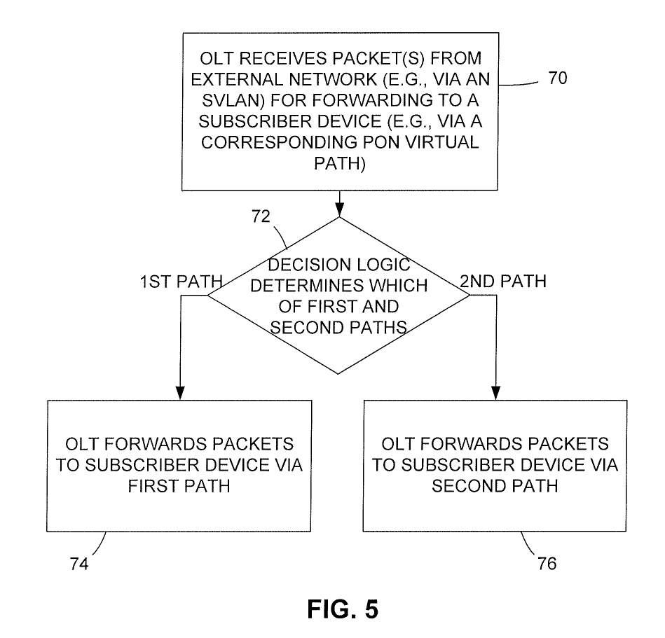

Although cross-connect logic 38 is capable of establishing a communication connection between any PON logical path (or link) and any SVLAN, in the exemplary embodiment of the invention cross-connect logic 38 maintains a one-to-one mapping between exactly one PON logical path and exactly one SVLAN for all of the PON logical paths and SVLANs. More specifically, and consistently with the mapping in conventional OLT cross-connect logic, cross-connect logic 38 can maintain the mapping between the user-network interface (UNI) port (not shown for purposes of clarity) of each of the above-referenced first and second ONTs 32 and one SVLAN. (Other embodiments of the invention can employ alternative pre-determined mappings or even dynamically determined mappings.) OLT 30 can perform a link-aggregation function in accordance with the IEEE 802.3ad standard to cause OLT 30 to treat upstream traffic (i.e., data packets) received from ONTs 32 via optical fiber network portions 34A and 34B as though they were received from the same physical interface rather than from the two separate interfaces 44 and 46. Cross-connect control logic 60 aids in controlling the mapping as well as performing the exemplary methods for routing network traffic described below with regard to FIGS. 4 and 5.

An exemplary method for routing upstream network traffic, i.e., from one of subscriber gateway devices 36 to OLT 30 (FIG. 2), is illustrated in FIG. 4. In this exemplary method, the upstream traffic is divided or apportioned between the two links in accordance with a suitable apportioning method. The apportionment can be predetermined in some embodiments. For example, each of the corresponding two ONTs 32 can transmit or forward to OLT 30 approximately one-half of the packets output by the subscriber gateway device 36 to which those ONTS 32 are connected so as to achieve what is sometimes referred to as load balancing. In an alternative example, each ONT 32 can transmit or forward all of the packets output by the subscriber gateway device 36 to which it is connected. In embodiments in which the apportionment is not predetermined or otherwise fixed or set, as a preliminary step 62 OLT 30 can command or instruct ONTs 32 as to what packets or what proportion of packets to forward by, for example, transmitting control plane messages to ONTs 32.

As indicated by step 64, OLT 30 receives some packets via the first link (through optical fiber network portion 34A) and, as indicated by step 66, receives some packets via the second link (through optical fiber network portion 34B). At step 68, OLT 30 uses the above-referenced link aggregation function to forward packets received via both links, as though they were the same link, to external aggregation network 28. Note that cross-connect logic 38 and its link aggregation function ensure that, regardless of from which path or link OLT 30 received the packets, the link is cross-connected to the SVLAN corresponding to the subscriber gateway device 36 from which the packets originated in the same manner in which conventional cross-connects ensure that the path from the subscriber gateway device is cross-connected to the corresponding SVLAN in conventional network arrangements.

An exemplary method for routing downstream network traffic, i.e., from OLT 30 to one of subscriber devices 36 (FIG. 2) is illustrated in FIG. 5. In this exemplary method, the downstream traffic is divided or apportioned between the two paths (or links) in accordance with a suitable apportioning method. As indicated by step 70, OLT 30 receives one or more packets from (an SVLAN of) external aggregation network 28 for forwarding to an addressed subscriber gateway device 36 (FIG. 2). At step 72, OLT 30 employs a suitable decision algorithm or method to determine whether to forward the packet or packets via the first link or the second link. The determination can be made on a per-packet basis, based upon the contents of the packet, a per-message (i.e., a sequence of packets) basis, or on any other suitable basis. At steps 74 and 76, OLT 30 forwards the packet or packets via either the first link (through optical fiber network portion 34A) or second link (through optical fiber network portion 34B), respectively.

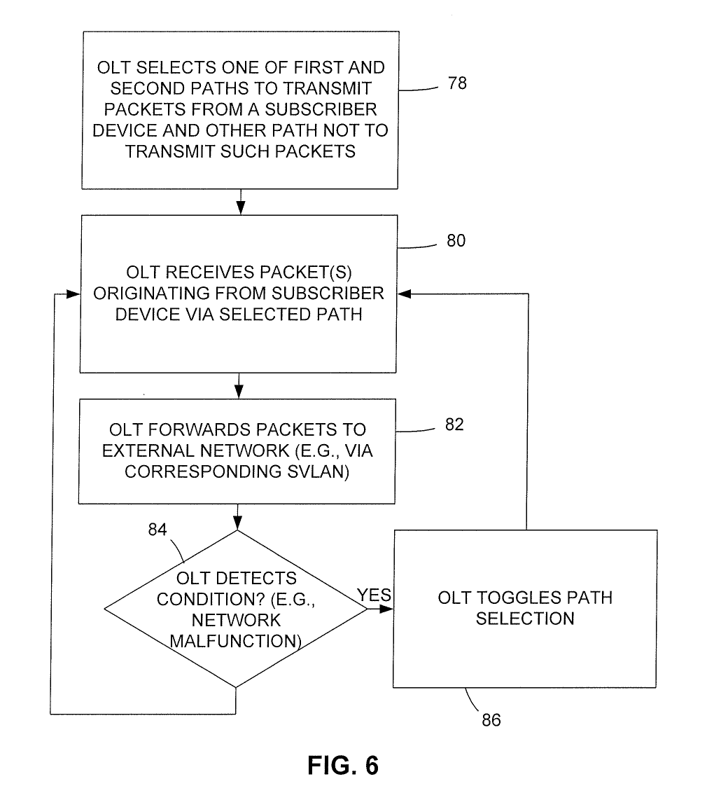

Another exemplary method for routing upstream network traffic is illustrated in FIG. 6. In this method, the upstream traffic is switched from one link to the other in response to detection of a condition, such as a network malfunction. At step 78, OLT 30 selects either the first link (through optical fiber network portion 34A) or the second link (through optical fiber network portion 34B). At step 80, OLT 30 receives one or more packets via the selected link from one of subscriber devices 36. At step 82, OLT 30 forwards the packets to external aggregation network 28 (on the SVLAN corresponding to the subscriber gateway device 36).

If, as indicated by step 84, OLT 30 detects a network malfunction, then at step 86 OLT 30 switches or toggles the path selection. That is, if the path previously selected was that which includes optical fiber network portion 34A, then the path that includes optical fiber network portion 34B is selected at step 86. Conversely, if the path previously selected was that which includes optical fiber network portion 34B, then the path that includes optical fiber network portion 34A is selected at step 86. Only one path is in a selected or active state at a time, and OLT 30 does not receive packets via the other (non-selected) path. The malfunction can be any that are known to be detectable in PONs by automated means (e.g., through an Operations, Administration and Management (OAM) system), such as a fiber break, line terminator card failure, ONT failure, UNI port failure, subscriber gateway failure, etc.

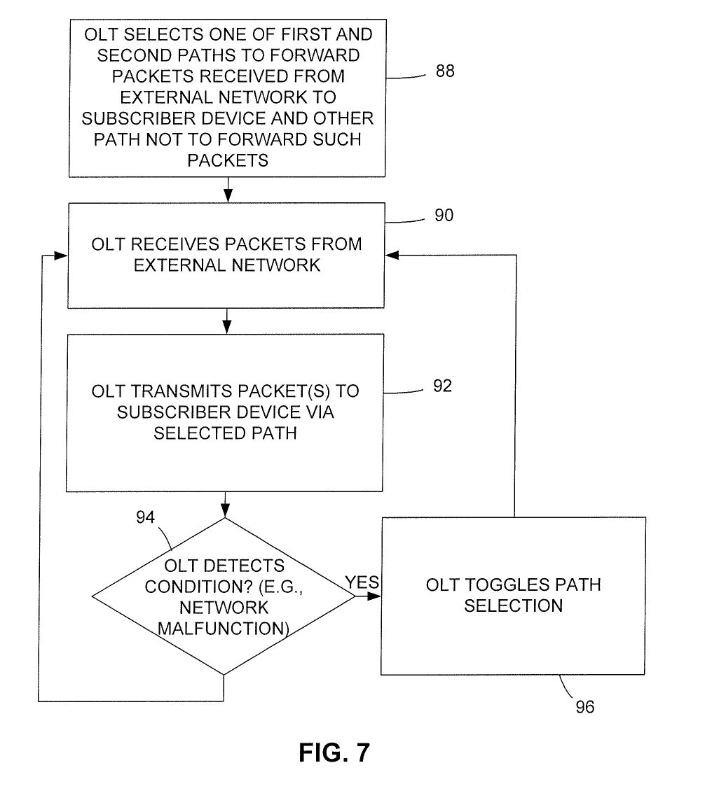

Another exemplary method for routing downstream network traffic is illustrated in FIG. 7. In this method, the downstream traffic is switched from one path (or link) to the other in response to detection of a condition, such as a network malfunction. At step 88, OLT 30 selects either the first link (through optical fiber network portion 34A) or the second link (through optical fiber network portion 34B). At step 90, OLT 30 receives packets from (an SVLAN of) external aggregation network 28. At step 92, OLT 30 transmits or forwards the one or more packets to the corresponding one of subscriber gateway devices 36 via the selected link.

If, as indicated by step 94, OLT 30 detects a network malfunction, then at step 96 OLT 30 switches or toggles the path selection. That is, if the link previously selected was that which includes optical fiber network portion 34A, then the link that includes optical fiber network portion 34B is selected at step 96. Conversely, if the link previously selected was that which includes optical fiber network portion 34B, then the link that includes optical fiber network portion 34A is selected at step 96. Only one link is in a selected or active state at a time, and OLT 30 does not transmit packets via the other (non-selected) link.

The methods described above with regard to FIGS. 4-7 can be combined with each other in any suitable manner. For example, the method described above with regard to FIG. 4 can be employed to route upstream packets in a load-balanced manner, and the method described above with regard to FIG. 7 can be employed to route downstream packets in a switched or toggled manner in response to a detected condition. Likewise, for example, the methods described above with regard to FIGS. 4 and 5 can be combined, or the methods described above with regard to FIGS. 6 and 7 can be combined, and so forth. Furthermore, different methods can be used at different times. For example, one method can be employed for routing the packets of one message, and then a different method can be employed for routing the packets of a subsequent message.

It will be apparent to those skilled in the art that various modifications and variations can be made to this invention without departing from the spirit or scope of the invention. Thus, it is intended that the present invention cover the modifications and variations of this invention provided that they come within the scope of any claims and their equivalents. With regard to the claims, no claim is intended to invoke the sixth paragraph of 35 U.S.C. Section 112 unless it includes the term “means for” followed by a participle.

What is claimed is:

1. A passive optical network (PON), comprising:
an Optical Line Terminal (OLT) for coupling an external network to the PON;
a first Optical Network Terminator (ONT) coupled to the OLT via a first optical fiber network portion;
a second Optical Network Terminator (ONT) coupled to the OLT via a second optical fiber network portion; and
a subscriber device coupled to the first ONT for communicating data with the OLT via a first link including the first ONT and coupled to the second ONT for communicating data with the OLT via a second link including the second ONT.

2. The PON claimed in claim 1, wherein the OLT includes link aggregation logic for including the first link and the second link in a link aggregation group.

3. The PON claimed in claim 1, wherein the OLT includes downstream forwarding logic for forwarding packets included in a transmission received from the external network and addressed to the subscriber device via either the first ONT or the second ONT but not both, the downstream forwarding logic detecting a condition and selecting either the first ONT or the second ONT for forwarding the packets of the transmission in response to the detected condition.

4. The PON claimed in claim 3, wherein the condition is a network malfunction.

5. The PON claimed in claim 3, wherein the OLT includes mapping logic for mapping each virtual local area network (VLAN) of a plurality of VLANS of the external network to a corresponding one of a plurality of subscriber devices, wherein the downstream forwarding logic forwards packets included in a transmission received from a virtual LAN of the external network to the corresponding subscriber device.

6. The PON claimed in claim 1, wherein the OLT includes downstream forwarding logic for forwarding packets included in a transmission received from the external network and addressed to the subscriber device via both the first ONT and the second ONT, the downstream forwarding logic forwarding a portion of the packets of the transmission via the first ONT and another portion of the packets of the transmission via the second ONT.

7. The PON claimed in claim 6, wherein the OLT includes mapping logic for mapping each virtual local area network (VLAN) of a plurality of VLANS of the external network to a corresponding one of a plurality of subscriber devices, wherein the downstream forwarding logic forwards packets included in a transmission received from a virtual LAN of the external network to the corresponding subscriber device.

8. The PON claimed in claim 1, wherein the OLT includes upstream forwarding logic for forwarding packets included in a transmission received from the subscriber device and addressed to the external network via either the first ONT or the second ONT but not both, the upstream forwarding logic detecting a condition and selecting to forward the packets received from the subscriber device via either the first ONT or the second ONT in response to the detected condition.

9. The PON claimed in claim 8, wherein the condition is a network malfunction.

10. The PON claimed in claim 8, wherein the OLT includes mapping logic for mapping each virtual local area network (VLAN) of a plurality of VLANS of the external network to a corresponding one of a plurality of subscriber devices, wherein the upstream forwarding logic forwards packets received from one of the subscriber devices to a corresponding virtual LAN of the external network.

11. The PON claimed in claim 1, wherein the OLT includes upstream forwarding logic for forwarding packets received from the subscriber device and addressed to the external network via both the first ONT and the second ONT, the upstream forwarding logic receiving a portion of the packets of the transmission via the first ONT and another portion of the packets of the transmission via the second ONT.

12. The PON claimed in claim 11, wherein the OLT includes mapping logic for mapping each virtual local area network (VLAN) of a plurality of VLANS of the external network to a corresponding one of a plurality of subscriber devices, wherein the upstream forwarding logic forwards packets received from one of the subscriber devices to a corresponding virtual LAN of the external network.

13. A method for routing network traffic in a passive optical network (PON) comprising an Optical Line Terminal (OLT) for coupling an external network to the PON, a first Optical Network Terminator (ONT) coupled to the OLT via a first optical fiber network portion, a second Optical Network Terminator (ONT) coupled to the OLT via a second optical fiber network portion, and a subscriber device coupled to the first ONT for communicating data with the OLT via a first link including the first ONT and coupled to the second ONT for communicating data with the OLT via a second link including the second ONT, the method comprising:
detecting a condition; and
switching network traffic from the first link to the second link in response to detection of the condition to enable data communication via the second link and prevent data communication via the first link.

14. The method claimed in claim 13, wherein the condition is a network malfunction.

15. The method claimed in claim 13, wherein the switching step switches network traffic from the first link to the second link only in a downstream direction from the OLT to the subscriber device and not in an upstream direction from the subscriber device to the OLT.

16. The method claimed in claim 13, wherein the switching step switches network traffic from the first link to the second link only in an upstream direction from the subscriber device to the OLT and not in a downstream direction from the OLT to the subscriber device.

17. The method claimed in claim 13, wherein the switching step switches network traffic from the first link to the second link in both an upstream direction from the subscriber device to the OLT and in a downstream direction from the OLT to the subscriber device.

18. A method for routing network traffic in a passive optical network (PON) comprising an Optical Line Terminal (OLT) for coupling an external network to the PON, a first Optical Network Terminator (ONT) coupled to the OLT via a first optical fiber network portion, a second Optical Network Terminator (ONT) coupled to the OLT via a second optical fiber network portion, and a subscriber device coupled to the first ONT for communicating data with the OLT via a first link including the first ONT and coupled to the second ONT for communicating data with the OLT via a second link including the second ONT, the method comprising:
apportioning network traffic involving the subscriber device between the first link and the second link.

19. The method claimed in claim 18, wherein the apportioning step apportions network traffic between the first link and the second link only in a downstream direction from the OLT to the subscriber device and not in an upstream direction from the subscriber device to the OLT.

20. The method claimed in claim 18, wherein the apportioning step apportions network traffic between the first link and the second link only in an upstream direction from the subscriber device to the OLT and not in a downstream direction from the OLT to the subscriber device.

21. The method claimed in claim 18, wherein the apportioning step apportions network traffic between the first link and the second link in both an upstream direction from the subscriber device to the OLT and in a downstream direction from the OLT to the subscriber device.
